(19) United States
(12) Patent Application Publication
(10) Pub. No.: US 2011/0050439 A1
(43) Pub. Date: Mar. 3, 2011

(54) PROTECTOR HAVING A DUAL-WARNING OUTER CASING

(76) Inventor: Robert WANG, Taoyuan County (TW)

(21) Appl. No.: 12/548,970

(22) Filed: Aug. 27, 2009

(51) Int. Cl. G08B 21/00

(52) U.S. Cl. 340/654

(57) ABSTRACT

A protector having a dual-warning outer casing includes a housing and a circuit board. The housing has one end formed with a pull portion. The pull portion has a through hole for insertion of an illuminating unit. The circuit board is disposed in the housing and includes two protection modules, a first alarm module and a second alarm module thereon. The first alarm module and the second alarm module are connected with the illuminating unit. Thereby, the protector is capable of sending warnings for abnormal circuit and high voltage via the illuminating unit.

### BACKGROUND OF THE INVENTION

1. Field of the Invention

The present invention relates to a protector having a dual-warning outer casing.

2. Description of the Prior Art

Generally, there is a protector disposed between a telecommunication cable and a switchboard apparatus for preventing the equipment from being damaged because of a short circuit or a lightning strike. A conventional protector comprises a protection circuit and an alarm circuit. The protection circuit uses a thermistor and a semiconductor discharge tube for protecting it from over voltage or over current. The alarm circuit uses an illuminating member to activate a photoresistor which is adapted to start a light emitting diode to radiate light for providing a warning to remind the maintenance personnel of abnormal circuit. However, the conventional protector is unable to remind the maintenance personnel of high voltage when the parts in the protector have a breakdown or aging, which may cause an accident because of getting an electric shock. Accordingly, the inventor of the present invention has devoted himself based on his many years of practical experiences to solve this problem.

### SUMMARY OF THE INVENTION

A protector having a dual-warning outer casing includes a housing and a circuit board. The housing has one end formed with a pull portion. The pull portion has a through hole for insertion of an illuminating unit. The circuit board is disposed in the housing and includes two protection modules, a first alarm module and a second alarm module thereon. The first alarm module and the second alarm module are connected with the illuminating unit. Thereby, the protector is capable of sending warnings for abnormal circuit and high voltage via the illuminating unit, preventing the maintenance personnel from getting an electric shock.

### BRIEF DESCRIPTION OF THE DRAWINGS

FIG. 1 is an exploded view according to a first embodiment of the present invention;

FIG. 2 is a partially enlarged view according to the first embodiment of the present invention;

FIG. 3 is a schematic view showing the circuit of a circuit board of the present invention; and

FIG. 4 is a partially enlarged view according to a second embodiment of the present invention.

### DETAILED DESCRIPTION OF THE PREFERRED EMBODIMENTS

Embodiments of the present invention will now be described, by way of example only, with reference to the accompanying drawings.

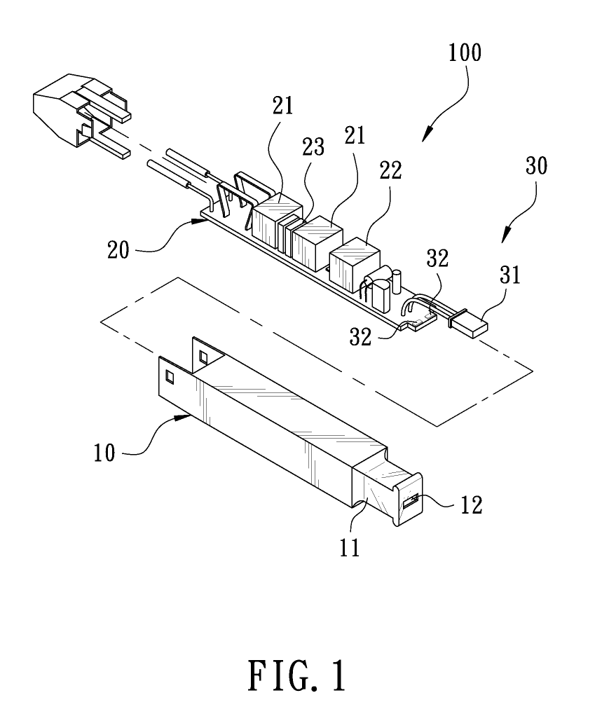

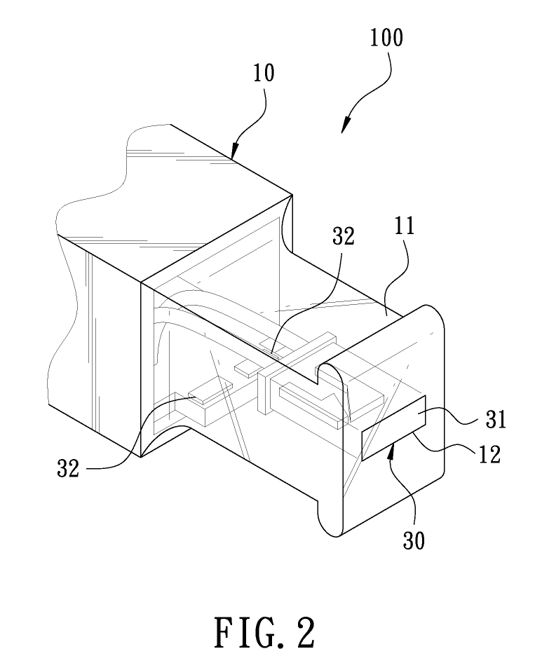

As shown in FIGS. 1 and 2, a protector 100 according to a first embodiment of the present invention is disposed between a telecommunication cable and a switchboard apparatus, and comprises a housing 10, a circuit board 20, and an illuminating unit 30.

The housing 10 has one end formed with a pull portion 11. The pull portion 11 is made of transparent material and formed with a through hole 12.

The circuit board 20 is disposed in the housing 10, and comprises two protection modules 21, a first alarm module 22 and a second alarm module 23 thereon.

The illuminating unit 30 is disposed in the pull portion 11 of the housing 10. In this embodiment, the illuminating unit 30 comprises a first light emitting diode 31 disposed in the through hole 12 and two second light emitting diodes 32 disposed on the circuit board 20. The first light emitting diode 31 is electrically connected to the first alarm module 22, and the second light emitting diodes 32 are electrically connected to the second alarm module 23.

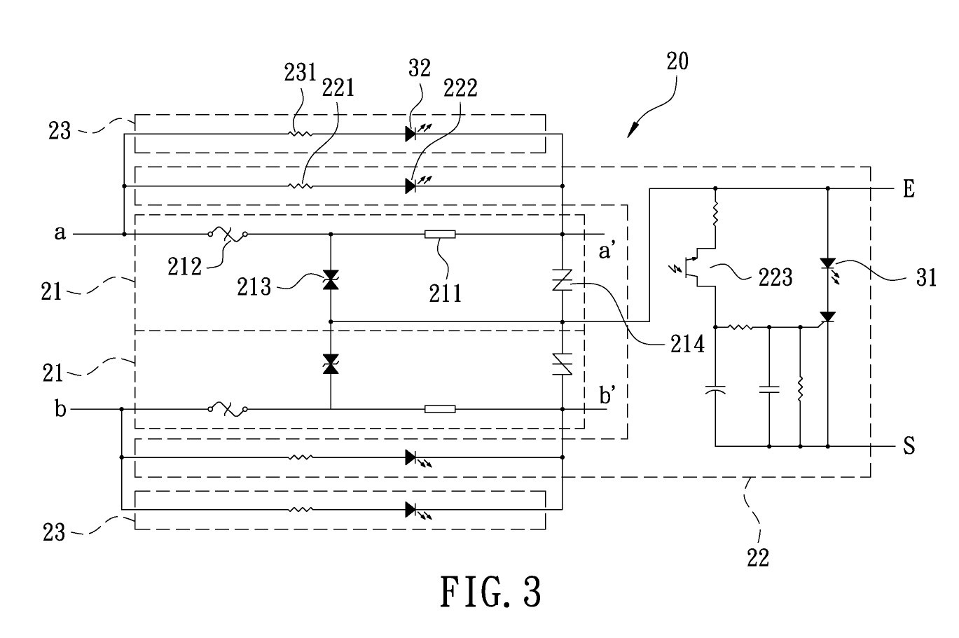

FIG. 3 is a schematic view showing the circuit of the circuit board of the present invention. The circuit board 20 includes a aa′ signal line, a bb′ signal line, a ground wire E. Each of the aa′ signal line and the bb′ signal line is provided with the protection module 21. The following description for the aa′ signal line provided with the protection module 21 is to give an example. The protection module 21 includes a thermistor 211 connected to the aa′ signal line in the way of series connection, a fuse 212 disposed in front of the thermistor 211, a semiconductor discharge tube 213 connected between the aa′ signal line and the ground wire E, and a voltage dependent resistor 214 connected between the aa′ signal line and the ground wire E.

The first alarm module 22 includes a first resistor 221 and a third light emitting diode 222 which are connected to the aa′ signal line/bb′ signal line in the way of parallel connection, and a phototransistor 223 located at a rear end of the protection module 21 and connected to the ground wire E in the way of series connection. The phototransistor 223 is close to the third light emitting diode 222, and has a rear end connected to the first light emitting diode 31 of the illuminating unit 30.

The second alarm module 23 includes a second resistor 231 connected to the aa′ signal line/bb′ signal line in the way of parallel connection. The resistance valve of the second resistor 231 is much greater than that of the first resistor 221. The second resistor 231 has a rear end connected to the second light emitting diode 32 of the illuminating unit 30.

Referring to FIGS. 2 and 3, in this embodiment when there is a surge on the aa′ signal line, the semiconductor discharge tube 213 of the protection module 21 will from a closed circuit and guide most current to the ground wire E. In the meantime, the resistance valve of the thermistor 211 will rise quickly, and partial current will be forced to go through the first alarm module 22 for starting the third light emitting diode 222 to radiate light. When the phototransistor 223 is shone, the first light emitting diode 31 of the illuminating unit 30 will be trigged to radiate light for warning the maintenance personnel of abnormal circuit. Because the resistance valve of the second resistor 231 of the second alarm module 23 is much greater than those of the first resistor 221 and the thermistor 211, only minimal current passes therethrough, which is unable to start the second light emitting diode 32 of the illuminating unit 30.

The parts in the protector 100 may become aging. In this embodiment, the semiconductor discharge tube 23 on the aa′ signal line becoming aging is given as an example. When there is a surge, the semiconductor discharge tube 231 fails to form a closed circuit. Thus, the resistance valve of the thermistor 211 rises quickly to form high current, which will blow the fuse 212. The current will be forced to go toward the first alarm module 22 and the second alarm module 23 for starting the first light emitting diode 31 and the second light emitting diode 32 to radiate light. The pull portion 11 of the housing 10 is made of transparent material such that the maintenance personnel is able to know that the protector 100 has high voltage when the second light emitting diodes 32 is radiating light, preventing the maintenance personnel from getting an electric shock.

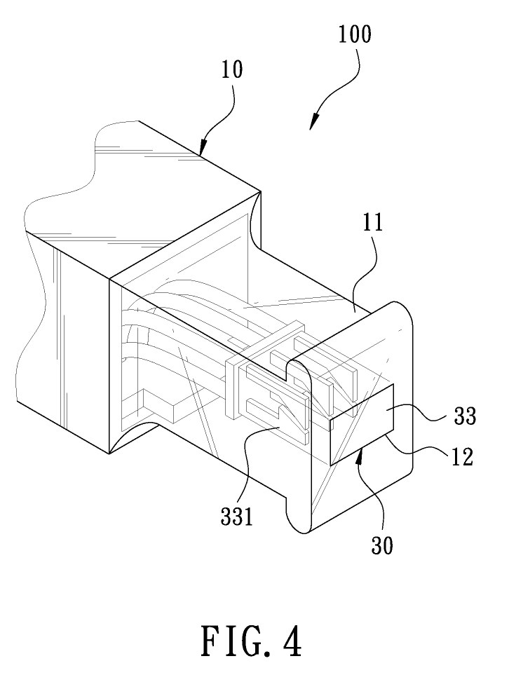

FIG. 4 is a perspective view of a second embodiment of the present invention, which is substantially similar to the first embodiment with the exceptions described hereinafter. The illuminating unit 30 is a multi-core light emitting diode 33 disposed in the through hole 12 of the pull portion 11. In this embodiment, the multi-core light emitting diode 33 has three cores 331. The central one is connected to the first alarm module 22 to radiate orange light, and the sideway ones are connected to the second alarm module 23 to radiate red light. Thereby, the illuminating unit 30 uses different color light to warn the maintenance personnel of abnormal circuit and high voltage.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A protector having a dual-warning outer casing, comprising:
a housing having one end formed with a pull portion, the pull portion having a through hole for insertion of an illuminating unit; and
a circuit board disposed in the housing, the circuit board comprising at least two protection modules, at least one first alarm module and at least two second alarm modules thereon, the first alarm module and the second alarm modules being connected with the illuminating unit.

2. The protector having a dual-warning outer casing as claimed in claim 1, wherein the pull portion is made of transparent material.

3. The protector having a dual-warning outer casing as claimed in claim 1, wherein the illuminating unit comprises a first light emitting diode disposed in the through hole and two second light emitting diodes disposed on the circuit board, the first light emitting diode being electrically connected to the first alarm module, and the second light emitting diodes being electrically connected to the second alarm modules, respectively.

4. The protector having a dual-warning outer casing as claimed in claim 1, wherein the illuminating unit is a multi-core light emitting diode disposed in the through hole.
